(19) United States
(12) Patent Application Publication
(10) Pub. No.: US 2004/0245163 A1
(43) Pub. Date: Dec. 9, 2004

(54) Purification device for ribonucleic acid in large volumes, and method

(76) Inventors: Gary Lim, San Francisco, CA (US); David W. Ruff, San Francisco, CA (US); Michael A. Tanner, Brentwood, CA (US); Somaya L. Bit, Fremont, CA (US)

Correspondence Address: KILYK & BOWERSOX, P.L.L.C., 3603 CHAIN BRIDGE ROAD, SUITE E, FAIRFAX, VA, 22030, US

(21) Appl. No.: 10/757,865

(22) Filed: Jan. 15, 2004

Related U.S. Application Data
(60) Provisional application No. 60/476,466, filed on Jun. 6, 2003.

(51) Int. Cl. B01D 29/00

(52) U.S. Cl. 210/323.1; 210/406; 210/489; 422/101; 435/287.1

(57) ABSTRACT

A device, system, kit, and method are provided for filtering relatively large volumes of whole blood to recover purified RNA for analysis. The device can include: a filter including a body having an interior, a first filter connector in communication with the interior of the body, a ribonucleic acid-capturing (RNA-capturing) membrane disposed within the interior, and an optional filter frit disposed within the interior adjacent the RNA-capturing membrane. The system can include a vacuum adapter plate including a substrate having a first surface, a second surface, and one or more through-holes each extending at least from the first surface to the second surface. The first filter connector can connect to a respective through-hole to form a fluid communication between the filter and the vacuum adapter plate. The system can include a collection vessel in fluid communication with the filter.

### CROSS-REFERENCE TO RELATED APPLICATION

This application claims the benefit under 35 U.S.C. Section 119(e) from earlier U.S. Provisional Patent Application No. 60/476,466, filed Jun. 6, 2003, which is incorporated herein in its entirety by reference.

### FIELD

The present teachings relate to large scale devices for filtration of ribonucleic acid (RNA) polynucleotides and RNA fragments, and methods for using same.

### BACKGROUND

The need to purify large amounts of ribonucleic acid (RNA) is often necessary when conducting gene expression studies. A device compatible with existing RNA chemistries and laboratory instruments capable of processing relatively large volumes of blood lysate utilizing standard laboratory equipment is desirable.

### SUMMARY

According to various embodiments, a purification device is provided that includes: a filter having a filter body including an interior, a first filter connector in communication with the interior of the body, a ribonucleic acid-capturing (RNA-capturing) membrane within the interior, and a vacuum adapter plate including a substrate having a first surface, a second surface, and one or more through-holes extending at least from the first surface to the second surface. The first filter connector can be connected to a respective one of the one or more through-holes to form a fluid communication between the filter and the vacuum adapter plate. The filter can optionally include a filter frit disposed within the interior adjacent the RNA-capturing membrane, for example, between the RNA-capturing membrane and the first filter connector.

According to various embodiments, purification devices are provided that enable the processing of multiple samples concurrently. The purification devices along with associated chemical reagents can be capable of recovering, for example, up to about 80%, up to about 90%, or up to about 100%, of the available ribonucleic acid (RNA) components from a blood sample. The blood sample can be a whole blood sample. Thus, a useful amount of RNA can be recovered from a minimal volume of blood. The recovered RNA can also be extremely pure according to various methods taught herein. The total recovered RNA can be intact. According to various embodiments, an RNA purification process can be completed in just a few minutes.

According to various embodiments, methods are provided including: providing a filter device including an interior, a sample introduction opening to the interior, an RNA-capturing membrane, and a frit in the interior to support the RNA-capturing membrane; providing a vacuum adapter plate including a substrate having a first surface and a second surface, and a plurality of through-holes extending from the first surface to the second surface, wherein the first filter connector connects to one of the plurality of through-holes to form an air-tight fluid communication between the filter and the vacuum adapter plate; providing a sample containing whole blood cells including RNA; introducing the sample through the sample introduction opening; contacting the sample with the RNA-capturing membrane; and capturing the RNA on or in the RNA-capturing membrane.

According to various embodiments, a purification system is provided that includes a purification device and a vacuum system. The purification device can include a filter body having an interior, a first filter connector integral with or separate from the filter body and in fluid communication with the interior of the filter body, an RNA-capturing membrane within the interior of the filter body, and a vacuum adapter plate including a substrate having a first surface and a second surface and one or more through-holes each extending at least from the first surface to the second surface, wherein the first filter connector is connected to a respective one of the one or more through-holes to form a fluid communication between the filter and the vacuum adapter plate. The filter body can optionally include a filter frit disposed within the interior and adjacent the RNA-capturing membrane, for example, disposed between the RNA-capturing membrane and the first filter connector. The vacuum system can include a vacuum source, a vacuum manifold connected to the vacuum source, and optionally a vacuum seal for sealing the vacuum adapter plate to the vacuum manifold. The second surface of the vacuum adapter plate can be operatively disposed in or on the vacuum manifold to create a pressure gradient across the RNA-capturing membrane.

According to various embodiments, a kit is provided including: at least one filter; at least one syringe body having a first interior volume, for example, an interior volume of at least about 5 ml; at least one syringe body having a second interior volume that differs from the first interior volume, for example, an interior volume of at least about 20 ml; and a vacuum adapter plate. The kit components can be packaged together, for example, in an openable container, in an air-tight package, or in a hermetically sealed package.

According to various embodiments, a purification device is provided that includes: a filter having a filter body including an interior, a first filter connector in communication with the interior of the body; a ribonucleic acid-capturing (RNA-capturing) membrane within the interior; and a collection vessel including an open-end and a closed-end. The first filter connector can connect to the open-end to form a fluid communication from the interior of the filter to the collection vessel.

Additional features and advantages of various embodiments will be set forth in part in the description that follows, and in part will be apparent from the description, or may be learned by practice of various embodiments. Other advantages of the various embodiments will be realized and attained by means of the elements and combinations particularly pointed out in the application.

It is to be understood that both the foregoing general description and the following detailed description are exemplary and explanatory only and are intended to provide a further explanation of the various and many embodiments described herein.

### BRIEF DESCRIPTION OF THE DRAWINGS

Various embodiments of the present teachings are exemplified in the accompanying drawings. The teachings are not limited to the embodiments depicted in the drawings, and include equivalent structures and methods as set forth in the following description and as would be known to those of ordinary skill in the art in view of the present teachings. In the drawings:

FIG. 1 is a perspective view of a system according to various embodiments;

FIG. 2 is a perspective view of a vacuum adapter plate according to various embodiments;

FIG. 3 is a perspective view of a filter according to various embodiments;

FIG. 4 is a side view of a filter according to various embodiments;

FIG. 5 is a cross-sectional side view taken along line 5-5 of FIG. 4;

FIG. 6 is a perspective exploded view of a filter according to various embodiments;

FIG. 7 is a perspective view of a collection plate and collection vessel according to various embodiments; and

FIG. 8 is a perspective view of a filter and a micro-elution vial according to various embodiments.

It is to be understood that both the foregoing general description and the following detailed description are exemplary and explanatory only and are intended to provide a further explanation of the various embodiments of the present teachings.

### DESCRIPTION OF VARIOUS EMBODIMENTS

According to various embodiments, a purification device is provided that includes: a filter including a filter body having an interior, a first filter connector in communication with the interior of the filter body, a ribonucleic acid-capturing (RNA-capturing) membrane disposed within the interior, and optionally a filter frit disposed within the interior adjacent the RNA-capturing membrane, for example, between the RNA-capturing membrane and the first filter connector. Herein, the term “RNA-capturing” refers to capturing RNA by a method that can include capturing RNA by a size exclusion filtration technique, capturing RNA by a chemical reaction, capturing RNA through a specific affinity binding reaction, capturing RNA by electrostatic or polar attraction, and/or by other RNA-immobilizing techniques. The RNA-capturing membrane can be or can include a species-immobilizing filter or filter material as described in co-pending U.S. patent application Ser. No. 09/994,495, filed Nov. 26, 2001, which is incorporated herein in its entirety by reference. The purification device can also include a vacuum adapter plate including a substrate having a first surface, a second surface, and one or more through-holes extending at least from the first surface to the second surface. The first filter connector can connect to a respective one of the one or more through-holes to form a fluid-tight fluid communication between the filter and the vacuum adapter plate.

According to various embodiments, the first filter connector can extend away from the filter body. The first filter connector can include a locking connection device or fitting. At least one of the one or more through-holes can include a first plate connector that extends away from a surface of the substrate. The first plate connector can provide a connecting device including a sample reservoir device in fluid communication with the filter.

The body of the filter can include a second filter connector disposed on an opposite side of the filter body relative to the first filter connector. The second filter connector can include a locking connecting device or fitting. The sample reservoir device can include a reservoir connector, and the second filter connector and the reservoir connector can connect with each other to form a fluid communication therebetween, for example, a fluid-tight communication.

According to various embodiments, the sample reservoir device can include a syringe body. The filter body can include a syringe body. The RNA-capturing membrane can include a plurality of RNA-capturing membranes. The RNA-capturing membrane can be porous and can have an average pore size diameter of from about 0.1 micron to about 50 microns, for example, from about one micron to about 10 microns. The RNA-capturing membrane can include a hydrophobic membrane. The hydrophobic membrane can include a glass fiber membrane.

According to various embodiments, the filter membrane can be a glass fiber membrane. The glass fiber membrane can have an average pore size diameter of, for example, from about 0.1 μm to about 50 μm, or from about one μm to about ten μm. The membrane can be, for example, a GF/D glass fiber membrane, catalog number 1823025, available from Whatman Inc., Clifton, N.J. The membrane can be, for example, from about 0.1 inches to about 1 inch, from about 0.40 inches to about 0.50 inches in diameter. The membrane can have a thickness of about, for example, 0.04 inches, 0.05 inches, 0.06 inches, or 0.07 inches.

According to various embodiments, the frit can include pores having an average pore size between from about 5 μm to about 200 μm, from about 20 μm to about 100 μm. The molded porous plastic frit can be obtained from, for example, Porex Corporation, Fairburn, Ga. The frit can support the membrane. The frit can improve the flow characteristics of the filter by providing an “air pocket” between the membrane and the outlet. The filter membrane and/or the filter frit can be hydrophobic. The frit can be manufactured from a porous plastic. The porous plastic can include a polyethylene material. Pores in the frit can have an average pore size of about 30 μm. The frit can be, for example, about 0.37 inches in diameter and can have a thickness of about 0.06 inches.

According to various embodiments, the filter device can include a two-piece plastic housing. The two-piece housing can include a first housing member and a second housing member. The two-piece housing can include joining devices for joining the first housing member and the second housing member. The joining devices can be molded or attached in the first housing member and/or the second housing member. A connecting device, for example, a Luer-Lok fitting, a Luer slip fitting, a compression fitting, can be incorporated into a connector. The two-piece housing can include a first filter connector. The first filter connector can be molded or attached to the two-piece housing. The two-piece housing can include a second filter connector. The second filter connector can be molded or attached to the two-piece housing. The first plate connector can include a Luer-Lok fitting and the second plate connector can include a Luer slip fitting, for example.

The two-piece housing can contain at least one ribonucleic acid-capturing membrane (RNA-capturing membrane). The two-piece housing can contain at least one frit, for example, disposed between the RNA-capturing membrane and the first filter connector of the filter device. The membrane and frit can reside in a hollow cylindrical region inside the two-piece housing, for example, in the first housing. With the membrane and frit assembled in place, the two halves of the housing can be joined into an air-tight device, for example, by ultrasonically welding one another to form an air-tight device. The filter device can include a support for the membrane adjacent to or proximal to the first filter connector of the filter device. The frit can be utilized as the support. Additionally or alternatively, a brace disposed in a sidewall or end-wall of the filter device can support the frit and/or the membrane. The brace can be a plastic. The brace can be manufactured integrated into the body of the filter device.

One or more blood-treatment components can be pre-filled in, or subsequently added to, the sample reservoir device. The one or more blood-treatment components can include, for example, one or more blood-stabilizing reagents, buffers, lysing reagents, and the like. For example, a lysing reagent can be disposed in the sample reservoir device. A whole blood sample can be disposed in the sample reservoir device. A blood-stabilizing reagent can be disposed in the sample reservoir device. A mixture of one or more blood-treatment components or reagents can be disposed in the sample reservoir device.

A sample can be safely collected in a collection vessel and stabilized therein. Isolation and purification of the RNA can proceed, thereafter. The purification device can be utilized with sample handling workstations. According to various embodiments, sample handling stations, for example, the ABI PRISM 6100 Nucleic Acid PrepStation, available from Applied Biosystems, Foster City, Calif., can be configured to use standard micro-titer-sized purification trays and can be utilized with the teachings herein. Further information about the ABI PRISM 6100 can be found at www.appliedbiosystems.com.

According to various embodiments, some or all of the components of a purification device can be plastic consumables. A plastic consumable can be provided to process relatively large volumes of blood samples. The consumable device can be compact. The consumable device can fit a vacuum station of ABI PRISM 6100 instrument, or other laboratory instruments configured to utilize micro-titer-sized purification trays. The consumable can be molded from PCR compatible plastic. The consumable can be disposable and can minimize sample contamination. According to various embodiments, the purification device can be provided as several components that can be assembled prior to conducting the purification. The purification device can include a vacuum adapter plate, at least one filter device, at least one reservoir, or a combination thereof.

The vacuum adapter plate can include a molded plastic plate or substrate having a first surface and a second surface. The substrate can provide one or more through-holes, for example, a plurality of through holes. For example, the substrate can include from about four to about eight through-holes, such as six through-holes. Each through-hole can include a connector. A connector can extend from the first surface and/or the second surface. The plate can have the same footprint as a micro-titer plate and can be compatible with industry standard liquid handling machines. The connectors on the second surface can serve as tips to direct fluids, for example, blood samples, pre-wash solutions, wash solutions, elution solutions, into an appropriate waste reservoir or collection plate as desired. A first plate connector disposed on or extending from the first surface can be formed and sized to be compatible with Luer slip fittings and Luer-Lok fittings. The first plate connector can couple or attach to a filter device providing a leak-free fluid communication. A second plate connector disposed on, or extending from the second surface of the vacuum adapter plate can be formed and sized to be compatible with Luer slip fittings and Luer Lock fittings. The second plate connector on the second surface can be operably aligned with, for example, collection vessels, wells, other plates, a vacuum source, or a combination thereof. According to various embodiments, collection vessels can be collection tubes, collection wells, collection vials, or other container suitable to collect an eluate from a filter device. The recovered RNA can be collected in vials, for example, two ml collection vials. Through-hole sealing devices, for example, vacuum caps-plugs, corks, sealing tapes, or the like, can be adapted to seal unused or vacant through-holes and can be disposed in, on or over the first surface and/or the second surface of the vacuum adapter plate. The through-hole sealing devices can prevent, for example, vacuum leaks, cross contamination, inefficient vacuum performance. During operation, unused through-holes in a vacuum adapter plate can be blocked using vacuum caps, Luer lock fittings, or tape to secure the opening. The sealing devices can be fitted on, in, or over the first connectors and/or the second connectors.

According to various embodiments, the purification device can utilize a plurality of different size reservoirs to accommodate different volumes of sample, wash, and/or elution solutions. The reservoirs can be, for example, off-the-shelf 5 ml and 20 ml disposable syringes. The syringes can be, for example, Becton Dickinson single-use-sterile 5 ml and 20 ml syringes, available from Becton Dickinson, Franklin Lakes, N.J. (5 ml, catalog number 309703 and 20 ml, catalog number 309661).

Alternatively, syringe plungers can be used to draw blood into a syringe reservoir pre-filled with one or more blood-treatment reagents. The syringe plunger can then be used to create a pressure differential across a filter membrane.

According to various embodiments, the purification device can include a vacuum adapter plate, at least one filter device, and at least one reservoir. Alternatively, or additionally, various embodiments of the purification device can have a filter membrane contained at the bottom of a reservoir, eliminating the need for a separate filter device. A purification device can be of unibody construction.

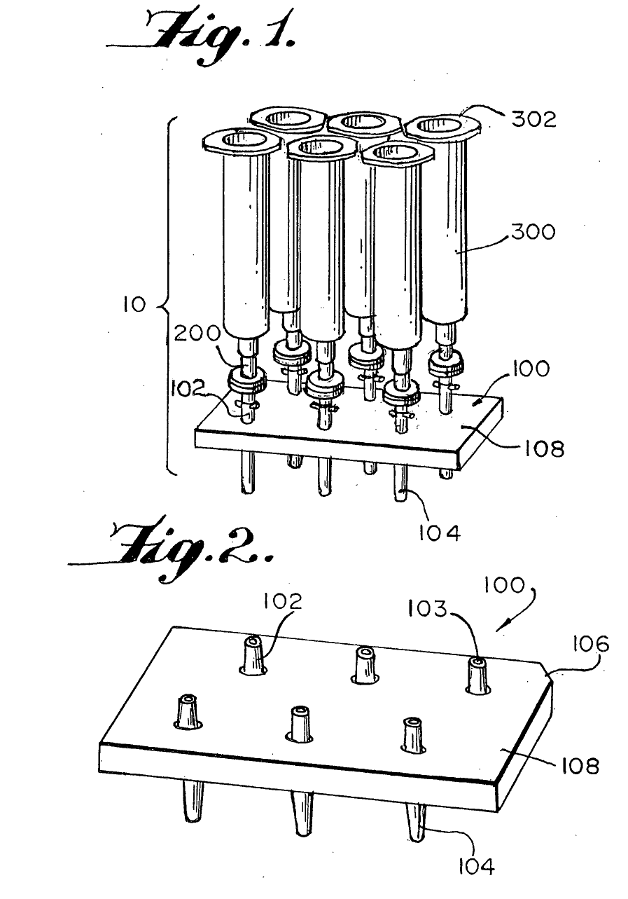

FIG. 1 is an elevated side view of a purification device according to various embodiments. The vacuum adapter plate 100 can have a footprint compatible with industry standard, 96 or 384 well micro-titer tray formats. The vacuum adapter plate 100 can include molded tips. The vacuum adapter plate 100 can include a first plate connector 102 extending from a first surface 108. A reservoir 300 including a sample input opening 302 can be attached to the first plate connector 102. A second plate connector 104 can extend from a second surface (not shown) of the vacuum adapter plate 100. The second plate connector, also known as a drip director, 104 can direct a filtrate to a collection vessel (not shown) of a collection plate (not shown). The vacuum adapter plate 100 can include a plurality of first plate connectors 102, for example, 4, 6, 8, 12, or more. The vacuum adapter plate 100 can include a plurality of second plate connectors 104, for example, 4, 6, 8, 12, or more. A filter device 200 can be disposed between a fluid communication from the reservoir 300 to the vacuum adapter plate 100. A syringe barrel with a connecting device, for example, Luer-Lok fittings, can be utilized as the reservoir 300. The syringe barrels can have an internal volume of, for example, about 5 ml or about 20 ml. The syringe barrels can have an internal volume of, for example, from about 1 ml to about 1000 ml, from about 1 ml to about 75 ml, or from about 5 ml to about 20 ml. A 20 ml or larger reservoir can be used to hold up to 20 ml of blood lysate. A 5 ml or larger reservoir including a connecting device can be used to hold smaller quantities of fluids required by purification process. Flow-through drip directors can be molded on the second surface. The locations of the through-holes can correspond to collection plate wells (not shown), for example, locations B3, B7, B11, G2, G6, G10 in a 96 well standard micro-titer tray format.

FIG. 2 illustrates an embodiment of a vacuum adapter plate 100. The vacuum adapter plate 100 can include a chamfered corner 106 to ensure proper orientation of the vacuum adapter plate 100 in a sample preparation device (not shown) during operation. The vacuum adapter plate 100 can include a through-hole 103 to transport fluid from the first surface 108 to the second surface (not shown). The vacuum adapter plate 100 can be molded from polypropylene. The polypropylene can be glass-filled, for example, PRO-FAX PD-702, available from Basell North America Inc., Elkton, Md. The vacuum adapter plate 100 can be, for example, about 5.0 inches in length, about 3.38 inches in width, and about 1.70 inches in height; about 6.0 inches in length, about 4.0 inches in width, and about 2.0 inches in height.

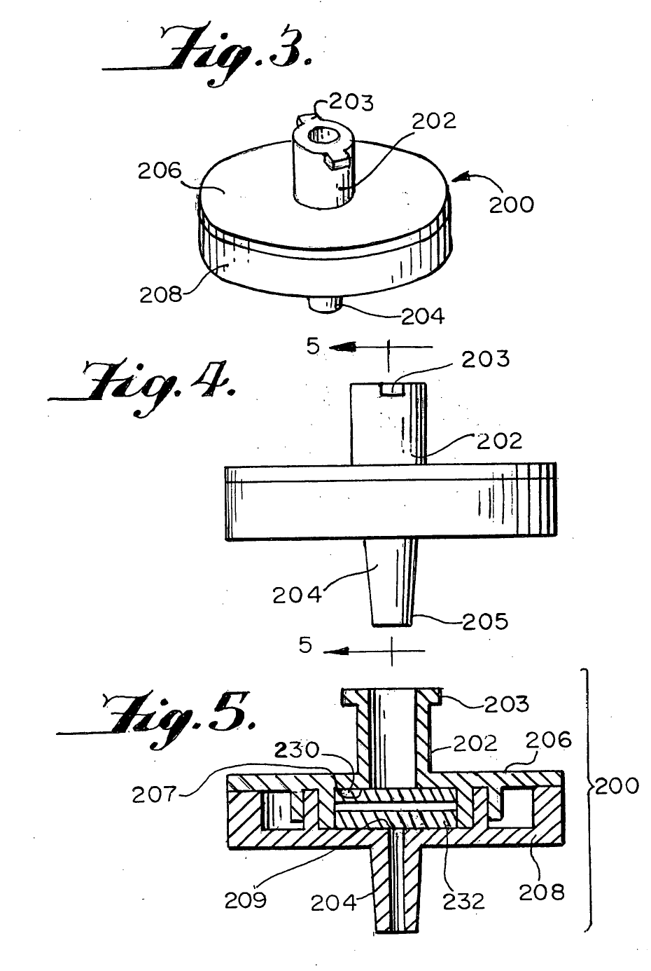

FIG. 3 depicts the filter device 200. The filter device 200 can include a first housing member 206 and a second housing member 208 that can be joined to form a two-piece housing, an air-tight unit. The two-piece housing can be interlocked. The two-piece housing can be sonically welded together. The filter device 200 can be used in-line. A first connecting device or locking fitting 203, for example, a Luer-Lok fitting, can be included on a first filter connector 202. A second connecting device (not shown), for example, a Luer slip fitting, can be included on a second filter connector 204.

FIG. 4 illustrates a side view of the filter device of FIG. 3. The second joining device 205, for example, a Luer slip fitting, can be seen disposed on the second filter connector 204.

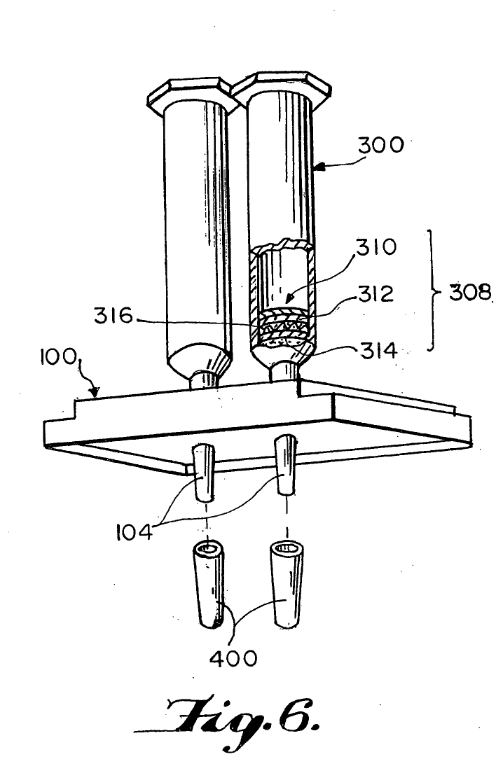

FIG. 5 depicts a cross-sectional view of the filter device 200 taken along line 5-5 of FIG. 4. Fluids can enter the filter device 200 through the first filter connector 202 adjacent a first surface 207 of the first housing member 206. A filter membrane 230 can be disposed adjacent to the first surface 207 between the first housing member 206 and the second housing member 208. Filtrate can flow from the second filter connector 204 disposed adjacent to a second surface 209 of filter device 200. A filter frit 232 can be placed adjacent to the second surface 209 between the first housing member 206 and the second housing member 208. According to various embodiments, the filter device 200 can be an air-tight unit containing a Whatman GF/D glass fiber membrane resting on top of a porous plastic frit with a pore size of 30 μm. The frit can prevent the membrane from sticking to the filter housing bottom when vacuum is applied. This can improve the flow characteristics of the filter device. The filter device housing can be molded from glass filled polypropylene, for example, PRO-FAX PD-702. The dimensions of the filter device housing can be, for example, approximately 0.65 inch X 1.12 inches.

FIG. 6 depicts a purification apparatus according to various embodiments. Reservoirs 300 are affixed to vacuum adapter plate 100. Bottom connectors 104 of vacuum adapter plate 100 can be in the presence of a vacuum and aligned with collection vessels 400 to collect filtrates, eluents, or other fluids for storage or further analysis. Reservoirs 300 include filter device 308. Filter device 308, as shown in FIG. 6, includes a Teflon O-ring 310, filters 312 and 316, such as Whatman GF/D membranes, and filter frit 314, such as a 30 μm porous frit. Connecting devices, for example, Luer fittings can be used to interconnect various components of the purification apparatus. The connecting device can permit quick, easy, and leak-free connections.

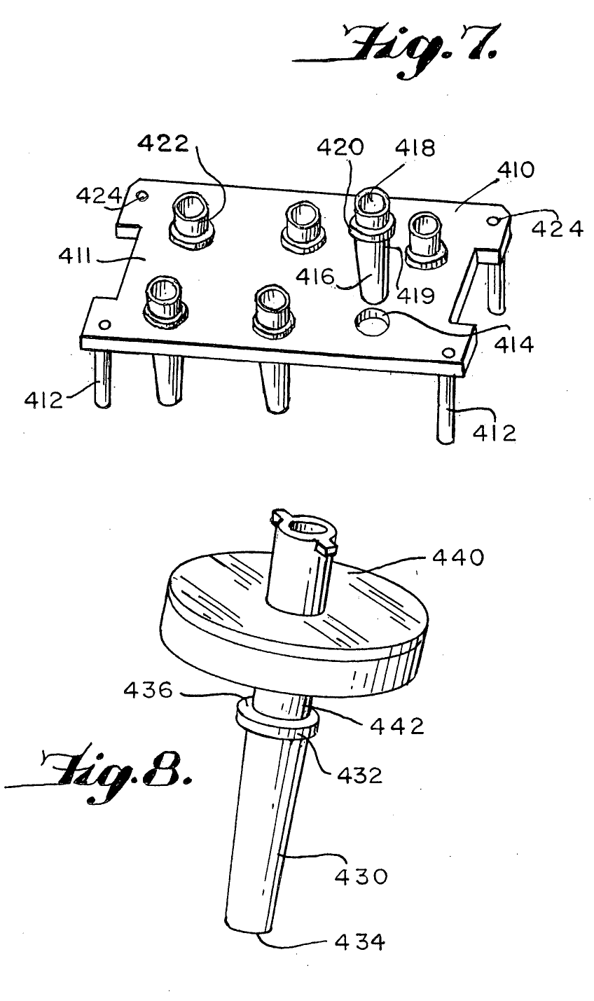

FIG. 7 depicts an adapter plate in the form of a collection plate 410. The collection plate 410 can include a plurality of through-holes 414 that can accommodate a respective plurality of collection vessels 416. In operation, the collection plate 410 can be positioned in a collection recess of a sample handling station, for example, in the collection recess (not the waste vacuum recess) of a 6100 PRISM or 6700 PRISM nucleic acid preparation station available from Applied Biosystems of Foster City, Calif. The collection plate 410 can be supported by a plurality of legs 412. The legs 412 can be attached to the collection plate 410 with screws 424 or can be integrally and/or unitarily formed as part of the collection plate 410. According to various embodiments, the through-holes 414 can be sized to hold micro-centrifuge tubes each having a volume of, for example, 1 ml, 2 ml, 4 ml, or 5 ml.

The collection vessels 416 can be of any suitable size and shape. Each collection vessel 416 can include an opening 418, a shoulder 420, and/or a plurality of frictionally engageable ridges 419. The shoulder 420 can brace the collection vessel 416 against a top surface 411 of the collection plate 410. The ridges 419 can provide a frictional holding force to keep the collection vessel 416 firmly disposed in the through-hole 414. The ridges 419 can be designed to provide, if desired, passageways to allow air to pass around the vessel 416 and through through-holes 414.

According to various embodiments, the collection plate can include four legs. According to various embodiments, the collection plate can include six through-holes. In an exemplary embodiment, the through holes can accommodate six 2 ml centrifuge tubes. According to various embodiments, some or all of the legs of the collection plate can have a bore that complements the shape of an interface at the bottom of the collection position of the sample preparation station. For example, the bores can fit into locating pins. According to various embodiments, the collection plate and the legs can be machined or molded from a polymer, for example, DELRIN available from Dupont of Wilmington, Del. An exemplary collection plate can have a length of about 5 inches, a width of about 3.4 inches and a thickness of about 0.2 inch. Each leg can have, as an example, an outer diameter of about 0.25 inch and a height of about 1.2 inches. According to various embodiments, two, three, four or more legs can be connected to the collection plate. According to various embodiments, the collection vessels can be two (2) ml micro-centrifuge tubes, for example, as available from Applied Biosystems of Foster City, Calif., part number 4305936. The collection vessles can be disposed in a reusable collection plate adapted for use in the ABI PRISM 6100 Nucleic Acid PrepStation. According to various embodiments, the collection plate can collect six eluates of two (2) ml each from six respective filter devices. Collection can occur simultaneously.

According to various embodiments, collection vessels can be micro-elution vials. FIG. 8 shows a micro-elution vial 430 connected with a filter device 440 using a second filter connector 442. According to various embodiments, the micro-elution vial 430 can include a closed end 434 and a shoulder 432 having a flat, planar top surface 436.

According to various embodiments, the micro-elution vial can be a small vial having a conical shape and a capacity of, for example, about 100 μL. The top of the micro-elution vial can be sized and shaped to connect to a second filter connector of a filter device. For example, the open top end of the micro-elution vial can have an inner diameter that is approximately the same or just larger than the outer diameter of the filter connector of an RNA-filtering device. According to various embodiments, the micro-elution vial can be used to collect highly concentrated purified RNA in small elution volumes. According to various embodiments, the micro-elution vial can be molded from glass-filled polypropylene, for example, PRO-FAX PD-702. The micro-elution vial can include a tube having an outer diameter of about 0.27 inches tapering to about 0.16 inches at a closed end. The micro-elution vial can have an overall length of about one inch, for example, about 1.06 inches.

According to various embodiments, a filter device including an RNA-capturing membrane with RNA bound on it, some eluent, and a collection vessel (for example, a micro-elution vial) in fluid communication with a second connector of the filter device, can altogether be disposed in a centrifuge. Upon spinning, eluant with eluted sample or an eluted sample component can be eluted into the collection vessel. The eluate can include the eluant and RNA, for example. According to various embodiments, eluate containing RNA can be extracted from the RNA-capturing membrane while a reservoir, filter device, and collection vessel assembly is maintained in an adapter plate, or without the adapter plate. The RNA concentration of the eluate collected in the collection vessel can be increased by repeating the elution and centrifugation of the assembly. For example, the eluate can be again passed through the filter device and collected in the collection vessel. Multiple recycling of eluant can be performed to increase the concentration of eluted RNA in the eluate. According to various embodiments, the eluate loaded back into the reservoir in which the eluant was originally disposed. According to various embodiments, an RNA extraction process using centrifugation can be employed and can use less eluant than would be required using vacuum extraction.

According to various embodiments, a vacuum adapter plate can support a load of 50 lbs where the load simulates the vacuum force imposed on the tray. According to various embodiments, a filter device can withstand a minimum of 100 pounds per square inch of pressure without bursting or leaking. According to various embodiments, a collection vessel, for example, a centrifuge tube, a micro-elution vial, can withstand a minimum of 1800 G forces when assembled to the tip of a filter device.

According to various embodiments, a purification system can be provided that includes: one or more purification devices; a vacuum adapter plate including a substrate having a first surface and a second surface, and one or more through-holes extending from the first surface to the second surface; a vacuum source; and a vacuum manifold connected to the vacuum source. Each purification device can include a filter that includes a body with an interior, a first filter connector in communication with the interior of the body, a ribonucleic acid-capturing (RNA-capturing) membrane within the interior; and a frit within the interior between the RNA-capturing membrane and the first filter connector. The first filter connector can be connected to one of the plurality of through-holes to form an air-tight fluid communication between the filter and the vacuum adapter plate. The second surface of the vacuum adapter plate can be operatively disposed in the vacuum manifold to create a pressure gradient across the RNA-capturing membrane. The system can include a vacuum seal disposed between the vacuum manifold and the vacuum adapter plate. The system can include one or more collection vessels disposed to receive fluids respectively from the one or more through-holes. The system can include a waste well disposed to receive waste vacuumed through the adapter plate through-holes.

According to various embodiments, a kit is provided that can include one or more of: at least one filter device; at least one syringe body having a first interior volume, for example, an interior volume of at least about 5 ml; at least one syringe body having a second interior volume that differs from the first interior volume, for example, an interior volume of at least about 20 ml; and a filter plate adapter. According to various embodiments, the kit can include a lysing reagent disposed in at least one 20 ml syringe body. According to various embodiments, the kit can include a blood-stabilizing reagent disposed in at least one 20 ml syringe body. According to various embodiments, one or more blood-treatment reagents can be provided mixed together, in a separate container, or pre-filled in at least one syringe body. The kit can include at least one collection vessel for example, from about four to about eight, such as six, collection vessels. The collection vessel can be or include a micro-centrifuge tube, a micro-elution vial, or the like. The kit can include at least one through-hole sealing device. The kit can include, for example, from about four to about eight, such as six, filter devices. The kit can include, for example, twelve or more 5 ml syringe bodies. The kit can include, for example, at least about four 20 ml syringe bodies. The kit can include, for example, at least about four 20 ml syringe bodies.

According to various embodiments, a method is provided wherein a sample containing RNA can be placed in at least one reservoir. A pressure gradient, caused, for example, by a vacuum or by centrifugal force, can be applied to move the sample from the at least one reservoir through the filter device. The pressure gradient can create a pressure differential of, for example, from about 1 pound per square inch (PSI) to about 20 PSI across a membrane of a filter device. The pressure gradient can be applied by applying a vacuum to the outlet end of one of the filter device or by causing a decreased pressure on the underside of a vacuum adapter plate. The vacuum can be supplied by a machine such as a nucleic acid sample preparation device, for example, the 6100 PRISM instrument, available from Applied Biosystems, Foster City, Calif.

The RNA that passes through the filter device can be captured on or bind to the filter membrane. The RNA can be eluted from the membrane using an elution solution.

Materials used in the manufacture of the purification device components, or the surfaces thereof, can be free from RNase, DNase, or other PCR inhibitors or contaminants, or at least free from detectable levels of such components. The purification device materials can be compatible with all chemistries used in the RNA extraction and/or purification method. The vacuum adapter plate can support a load of, for example, about 10 pounds per square inch from a vacuum force imposed on the tray. The filter device can be capable of withstanding, for example, about 30 pounds per square inch (PSI) of vacuum pressure, without leaks. The purification device can withstand temperatures of, for example, from about −20° C. to about 100° C., or more, without warping. The temperature requirements for the purification device can be based on temperature extremes during shipping or during use, for example, during PCR. The purification device components can be used at least once. The purification device can be disposed according to applicable waste/hazard standards.

According to various embodiments, an RNA purification kit for use with blood or whole blood can be provided. The kit can contain the necessary plastic consumables to process at least one sample having a total volume of about, for example, 5 ml, 15 ml, 30 ml, 60 ml, 120 ml, or more, of blood lysate. Each kit can contain at least one purification device including, for example, one (1) vacuum adapter plate, six (6) filter devices, six (6) 20 ml reservoirs, and/or eighteen (18) 5 ml reservoirs. Reagents, known in the art, necessary to lyse the blood sample, can be disposed in the reservoirs included with the kit. Reagents, known in the art, necessary to preserve the blood sample for a predetermined duration, can be disposed in the reservoirs included with the kit. The vacuum adapter plate, filter devices, and reservoirs, can be packaged in separate polymeric bags. The bagged components can be packaged or prepackaged in preprinted boxes. All reagents that can be used in the purification device can be packaged separately or can be packaged with the purification device. Some or all reagents can be included in none, some, or all of the kits. For example, Nucleic Acid Purification Wash Solution I (Part No. 4305891), Nucleic Acid Purification Wash Solution II (Part No. 4305890), AbsoluteRNA Wash Solution (Part No. 4305545), and Nucleic Acid Purification Elution Solution (Part No. 4305893), available from Applied Biosystems, Foster City, Calif., can be packaged with the purification kits. A kit and its component parts can have a predetermined shelf-life, including an indefinite shelf-life, when properly sealed and packaged.

A 20 ml or larger reservoir can be used to hold up to about 20 ml of blood lysate. Once the blood lysate has filtered through the filter device 200, the 20 ml reservoirs can be discarded and replaced with 5 ml reservoirs. Subsequent wash steps can be performed with the 5 ml reservoir. Prior to the elution step, the 5 ml reservoir can be replaced with a fresh reservoir to minimize any contamination, such as from heme.

According to various embodiments, methods are provided including: providing a filter device including an interior, a sample introduction opening to the interior, an RNA-capturing membrane, and a frit in the interior to support the RNA-capturing membrane; providing a vacuum adapter plate including a substrate having a first surface and a second surface, and a plurality of through-holes extending from the first surface to the second surface, wherein the first filter connector connects to one of the plurality of through-holes to form an air-tight fluid communication between the filter and the vacuum adapter plate; providing a sample containing whole blood cells including RNA; introducing the sample through the sample introduction opening; contacting the sample with the RNA-capturing membrane; and capturing the RNA onto the RNA-capturing membrane.

According to various embodiments, methods can include washing the sample, excluding the bound RNA, from the RNA-capturing membrane. Methods can include eluting the bound RNA from the filter membrane. The bound RNA can be recovered in a collection vessel. Methods can include drying the filter membrane prior to the eluting step. Methods can include creating a pressure gradient for eluting the RNA. Methods can include pre-wetting the RNA-capturing membrane before the step of moving the sample across the filter membrane. Methods can include creating a pressure gradient for moving the sample. Methods can include creating a pressure gradient for washing the sample. The sample can have a volume of about 5 ml to about 20 ml.

### EXAMPLE 1

A 3 ml sample of fresh whole blood was drawn into a TEMPUS blood RNA tube, available from Applied Biosystems, Foster City, Calif., and shaken vigorously for about 10 to 20 seconds. The stabilized blood sample can be stored at room temperature for up to five days, stored at between about −20° C. to about −80° C. for an extended period of time, or processed by diluting the sample with PBS to extract the RNA. A 20 ml reservoir was connected to a filter device, and the filter device was then connected to a vacuum adapter plate.

A splash guard was inserted into the bottom of the waste position of an ABI PRISM 6100. The vacuum adapter plate was inserted in the purification tray carriage. The edges of the plate were pressed down to insure that the plate was properly sealed. The plate was locked into position by rotating the locking knobs. The ABI PRISM 6100 was programmed using the TEMPUS Blood RNA Tube and Large Volume Consumable Protocol, part no. 4345218, available from Applied Biosystems, Foster City, Calif.

The samples were diluted with 3 ml of 1× concentration PBS and shaken vigorously for about 10 to 20 seconds. The filter device was pre-wetted by pipetting about 350 μL of Nucleic Acid Purification Wash Solution I, available from Applied Biosystems, Foster City, Calif., into the filter device. The lysed blood sample was loaded into the reservoir and vacuumed through the filter device at about 80% vacuum for an average of about 500 seconds. The empty reservoir was removed and the neck of the filter device was washed with Nucleic Acid Purification Wash Solution I to remove any debris prior to attaching a new reservoir. A 5 ml reservoir was attached, loaded with 4.5 ml of Nucleic Acid Purification Wash Solution I, and the solution was vacuumed through the filter device at 80% vacuum for an average of about 500 seconds. 4.5 ml of Nucleic Acid Purification Wash Solution II, available from Applied Biosystems, Foster City, Calif., was pipetted into the reservoir and vacuumed through the filter device at 80% vacuum for about 180 seconds. Vacuuming of Nucleic Acid Purification Wash Solutions I and II through the filter device were repeated until the filter device was free of heme. 80% vacuum was run until the filter was dry.

A new 5 ml reservoir was attached to the filter device and 0.35 ml of AbsoluteRNA Wash Solution, available from Applied Biosystems, Foster City, Calif., was added to the reservoir and allowed to incubate for approximately 900 seconds with 0% vacuum. 3 ml of Nucleic Acid Purification Wash Solution II was added to the reservoir and allowed to incubate for approximately 300 seconds at 0% vacuum. 80% vacuum was then applied for approximately 120 seconds to remove the wash solutions. 3 ml of Nucleic Acid Purification Wash Solution II was added to the reservoir and vacuumed through the filter device at about 80% vacuum for approximately 120 seconds. Another 3 ml of Nucleic Acid Purification Wash Solution II and vacuumed through the filter device again at 80% vacuum for approximately 120 seconds. The vacuum adapter plate was removed and the tips of the plate and the splash guard were washed with 70% ethanol. The attached 5 ml reservoirs were removed and discarded. 90% vacuum for approximately 400 seconds was applied across the filter device to dry the filter. The vacuum plate adapter was touched off at the waste position.

A 3 ml collection vessel was inserted into a collection plate. The collection plate was loaded into the collection position of the ABI PRISM 6100. A new 5 ml reservoir was attached to the filter device and 0.5 ml of Nucleic Acid Purification Elution Solution was added to the reservoir and allowed to incubate for approximately 120 seconds at 0% vacuum. 60% vacuum was then applied across the filter device for approximately 120 seconds to elute the RNA. The volume of the eluate recovered in the collection vessel was approximately 400 μl. Vacuum can be applied again at a higher percentage to elute any remaining RNA. The vacuum adapter plate was then touched off at the collection position. The eluate was then removed for analysis. The consumables were removed and discarded and the Quick Run feature of the ABI PRISM 6100 was used to flush the waste position with water using 50% vacuum for approximately 3 minutes. The splash guard holder was cleaned with 70% ethanol, detergent, and water. The area around the vacuum carriage and gasket was cleaned with 70% ethanol.

Prior to using the purification device, the blood sample can be lysed using enzymes or other biochemical or biomechanical reactions. The blood sample can be stored prior to purification. The blood sample can be lysed before or after storage. After purification, the collection vessels, vials, or plates can be stored prior to further processing. The collection vessels, vials, or plates can be sealed with covers, caps, or the like, and stored without further handling. Reagents to stabilize the blood sample or the purified sample for storage can be added before purification processing or after purification processing, respectively. For example, reagents can be added to stabilize and preserve a blood sample for up to 30 days prior to purification.

Other embodiments will be apparent to those skilled in the art from consideration of the present specification and practice of various embodiments disclosed herein. It is intended that the present specification and examples be considered as exemplary only with a true scope and spirit indicated by the teachings and equivalents thereof.

What is claimed is:

1. A purification device comprising:
a filter, the filter comprising
a filter body that includes an interior,
a first filter connector in fluid communication with the interior, and
at least one ribonucleic acid-capturing (RNA-capturing) membrane disposed within the interior; and
a vacuum adapter plate comprising a substrate including a first surface, a second surface, and one or more through-holes extending at least from the first surface to the second surface;
wherein the first filter connector is capable of connecting to the vacuum adapter plate to form a fluid communication from the interior of the filter to a respective one of the one or more through-holes.

2. The purification device of claim 1, wherein the first filter connector extends away from the filter body.

3. The purification device of claim 1, wherein each of the one or more through-holes further comprises a tubular connector that extends away from the substrate.

4. The purification device of claim 1, further comprising a sample reservoir device that includes a connector capable of connecting the sample reservoir device to the filter to form a fluid communication between the sample reservoir device and the filter.

5. The purification device of claim 4, further comprising one or more blood-treatment components disposed in the sample reservoir device.

6. The purification device of claim 4, further comprising one or more blood-treatment reagents disposed in the sample reservoir device.

7. The purification device of claim 4, further comprising a lysing reagent, a blood-stabilizing reagent, and an anti-coagulant, disposed in the sample reservoir device.

8. The purification device of claim 4, further comprising a lysing reagent disposed in the sample reservoir device.

9. The purification device of claim 4, further comprising a blood-stabilizing reagent disposed in the sample reservoir device.

10. The purification device of claim 4, further comprising a whole blood sample disposed in the sample reservoir device.

11. The purification device of claim 4, wherein the filter body further comprises a second filter connector disposed on an opposite side of the filter body relative to the first filter connector.

12. The purification device of claim 8, wherein the sample reservoir device includes a reservoir connector, and the second filter connector and the reservoir connector are capable of connecting to each other to form a fluid communication therebetween.

13. The purification device of claim 4, wherein the sample reservoir device comprises a syringe body.

14. The purification device of claim 1, further comprising a filter frit disposed in the interior of the filter body adjacent the RNA-capturing membrane.

15. The purification device of claim 1, wherein the filter body comprises a syringe body.

16. The purification device of claim 1, wherein the at least one RNA-capturing membrane comprises a plurality of RNA-capturing membranes.

17. The purification device of claim 1, wherein the plurality of through-holes comprises from about four to about eight through-holes.

18. The purification device of claim 1, wherein the RNA-capturing membrane is porous and has an average pore size diameter of from about 1 micron to about 10 microns.

19. The purification device of claim 1, wherein the at least one RNA-capturing membrane comprises a hydrophobic membrane.

20. The purification device of claim 19, wherein the hydrophobic membrane comprises a glass fiber membrane.

21. The purification device of claim 14, wherein the filter frit is porous and has an average pore size diameter of from about 20 microns to about 100 microns.

22. The purification device of claim 14, wherein the filter frit comprises a plastic material.

23. The purification device of claim 14, wherein the filter frit comprises a polyethylene material.

24. The purification device of claim 1, wherein the vacuum adapter plate further comprises a drip director extending away from the second surface of the substrate disposed in fluid communication with a respective one of the one or more through-holes.

25. The purification device of claim 24, wherein the drip director includes at least a portion that is conical.

26. The purification device of claim 2, wherein the first filter connector comprises a locking fitting.

27. A purification system comprising:
the purification device of claim 1,
wherein the first filter connector is connected to a respective one of the one or more through-holes, and the purification system further comprises;
a vacuum source; and
a vacuum manifold connected to the vacuum source;
wherein the second surface of the vacuum adapter plate is operatively disposed in the vacuum manifold such that in operation a pressure gradient is created across the RNA-capturing membrane.

28. The purification system of claim 27, further comprising a seal disposed between the vacuum manifold and the vacuum adapter plate.

29. The purification system of claim 27, further comprising at least one collection vessel disposed in the vacuum manifold and arranged to receive fluids drawn through the one or more through-holes.

30. A kit, comprising:
at least one filter, the at least one filter comprising;
a filter body that includes an interior,
a first filter connector in fluid communication with the interior, and
at least one ribonucleic acid-capturing (RNA-capturing) membrane disposed within the interior;
at least one syringe body having an interior volume of at least about 5 ml and including a connector capable of forming a fluid communication with the first filter connector;
at least one syringe body having an interior volume of at least about 20 ml and including a connector capable of forming a fluid communication with the first filter connector; and
a vacuum adapter plate comprising a substrate, at least one through-hole, extending through the substrate, and a connector capable of forming a fluid communication with the first filter connector.

31. The kit of claim 30, further comprising a container and one or more blood-treatment components disposed in the container.

32. The kit of claim 30, further comprising a container and a lysing reagent disposed in the container.

33. The kit of claim 30, further comprising a container and a blood-stabilizing reagent disposed in the container.

34. The kit of claim 30, further comprising at least one collection vessel.

35. The kit of claim 30, wherein the at least one through-hole comprises a plurality of through-holes, and the kit further comprise at least one through-hole sealing device.

36. The kit of claim 30, wherein the at least one filter comprises from about four to about eight filters.

37. The kit of claim 30, wherein the at least one syringe body having an interior of about 5 ml comprises at least twelve syringe bodies each having an interior volume of at least about 5 ml.

38. A method, comprising the steps of:
providing at least one filter including an interior, a sample introduction opening in fluid communication with the interior, an output opening in fluid communication with the interior, and an RNA-capturing membrane disposed in the interior;
providing a vacuum adapter plate comprising a substrate having a first surface, a second surface, and one or more through-holes extending at least from the first surface to the second surface, wherein the sample introduction opening is connected to a respective one of the one or more through-holes such that a fluid communication is provided between the at least one filter and the vacuum adapter plate;
introducing a sample containing whole blood cells including ribonucleic acid (RNA) through the sample introduction opening and into the interior of the filter;
contacting the sample with the RNA-capturing membrane; and
causing capturing of the RNA in the sample to the RNA-capturing membrane.

39. The method of claim 38, further comprising washing the sample, excluding the captured RNA, off of the RNA-capturing membrane.

40. The method of claim 38, further comprising eluting the captured RNA off of the RNA-capturing membrane.

41. The method of claim 40, further comprising collecting the eluted RNA in a container.

42. The method of claim 40, further comprising drying the RNA-capturing membrane prior to eluting the captured RNA.

43. The method of claim 40, wherein eluting the captured RNA comprises creating a pressure gradient across the RNA-capturing membrane.

44. The method of claim 38, further comprising pre-wetting the RNA-capturing membrane before causing the capturing of the RNA in the sample to the RNA-capturing membrane.

45. The method of claim 38, wherein introducing the sample comprises creating a pressure gradient across the at least one filter.

46. The method of claim 39, wherein washing the sample comprises creating a pressure gradient across the RNA-capturing membrane.

47. The method of claim 38, wherein the sample introduced has a volume of from about five ml to about 20 ml.

48. A purification device comprising:
a filter, the filter comprising
a filter body that includes an interior,
a first filter connector in fluid communication with the interior, and
at least one ribonucleic acid-capturing (RNA-capturing) membrane disposed within the interior;
a collection vessel including a first open end and a second closed end; and
an adapter plate including one or more through-holes sized to accommodate the collection vessel;
wherein the first filter connector is capable of connecting to the first open end to form a fluid communication from the interior of the filter to the collection vessel.

49. The purification device of claim 48, further comprising a sample reservoir device that includes a connector capable of connecting the sample reservoir device to the filter to form a fluid communication between the sample reservoir device and the filter.

50. The purification device of claim 48, wherein the collection vessel further comprises a tubular body extending from the opening, and a shoulder disposed on the tubular body.

51. The purification device of claim 48, wherein the adapter plate comprises a substrate including a first surface, a second surface, each of the one or more through-holes extends at least from the first surface to the second surface, and the collection vessel is disposed in one of the one or more through-holes.

52. The purification device of claim 51, wherein the collection vessel further comprises a tubular body including a shoulder adjacent the first open end and wherein the shoulder contacts the first surface of the adapter plate.

53. A purification system comprising:
the purification device of claim 51;
a vacuum source; and
a vacuum manifold connected to the vacuum source;
wherein the second surface of the adapter plate is operatively disposed in the vacuum manifold such that in operation the system is capable of creating a pressure gradient across the RNA-capturing membrane.

54. A method, comprising the steps of:
providing the purification device of claim 51; and
spinning the purification device.
